(19) United States
(12) Patent Application Publication
(10) Pub. No.: US 2024/0354598 A1
(43) Pub. Date: Oct. 24, 2024

(54) SYSTEMS, APPARATUSES, METHODS, AND COMPUTER PROGRAM PRODUCTS FOR DATA-DRIVEN PREDICTIONS WITHIN A PROCESS SIMULATION SYSTEM

(71) Applicant: Honeywell International Inc., Charlotte, NC (US)

(72) Inventors: John Goodman, Katy, TX (US); Abhishek Pednekar, West Hills, CA (US); Mahboubeh Hejazibakhsh, Atlanta, GA (US)

(21) Appl. No.: 18/304,251

(22) Filed: Apr. 20, 2023

(51) Int. Cl. G06N 5/022

(52) U.S. Cl. CPC G06N 5/022

(57) ABSTRACT

Embodiments of the disclosure provide for data-driven predictions within a process simulation system. Some embodiments, generate a data-driven model configured to output first model-predicted data associated with at least one process of an industrial plant. The first model-predicted data may include a predicted value for each of one or more target process variables associated with the at least one process. The data-driven model may be integrated within a process simulation model. The process simulation model may be configured to simulate the execution of the at least one process at one or more operating conditions of a plurality of operating conditions. The process simulation model may be deployed for use.

### TECHNOLOGICAL FIELD

Embodiments of the present disclosure generally relate to process simulation, and specifically to data-driven process prediction within a process simulation system.

### BACKGROUND

Various embodiments of the present disclosure address technical challenges related to process simulation. Through applied effort, ingenuity, and innovation, Applicant has solved problems related to process simulation by developing solutions embodied in the present disclosure, which are described in detail below

### BRIEF SUMMARY

In general, embodiments of the present disclosure herein provide for data-driven predictions within a process simulation system. Other implementations for data-driven predictions within a process simulation system will be, or will become, apparent to one with skill in the art upon examination of the following figures and detailed description. It is intended that all such additional implementations be included within this description, be within the scope of the disclosure, and be protected by the following claims.

In accordance with one aspect of the present disclosure, a computer-implemented method for data-driven model predictions within a process simulation system is provided. The computer-implemented method is executable utilizing any of a myriad of computing device(s) and/or combinations of hardware, software, and/or firmware. In some example embodiments, an example computer-implemented method include generating, based on a training dataset, a data-driven model configured to output first model-predicted data associated with at least one process of an industrial plant, wherein the first model-predicted data comprise a predicted value for each of one or more target process variables associated with the at least one process; integrating the data-driven model within a process simulation model, wherein the process simulation model is configured to simulate the execution of the at least one process at one or more operating conditions of a plurality of operating conditions; and deploying the process simulation model for use.

In some example embodiments, the process simulation model comprise the data-driven model and a first principles model.

In some example embodiments, the first principles model is configured to generate second model-predicted data, wherein the second model-predicted data comprise a predicted value for each of one or more other process variables relative to the target process variables,

In some example embodiments, deploying the process simulation model for use comprise receiving input data, wherein the input data comprise process data associated with the at least one process; generating, using the data-driven model, the first model-predicted data; applying the model-predicted data in one or more of (i) engineering studies or (ii) offline optimization operation.

In some example embodiments, the first model-predicted data is implemented as a constraint in one or more of engineering studies or optimization operation.

In some example embodiments, the data-driven model is configured to model the at least one process.

In some example embodiments, the data-driven model comprises a neural network model.

In some example embodiments, the data-driven model comprises a regression model.

In some example embodiments, the data-driven model is previously trained using one or more supervised training techniques.

In some example embodiments, the data-driven model is trained using the training dataset, wherein the training dataset comprises a plurality of sets of historical process data and corresponding ground truth data for one or more target process variables.

In some examples embodiments, the historical process data in each set of historical process data and corresponding ground truth data comprises one or more of (i) historical predicted values for the one or more target process variables or (ii) historical values for a set of measured process variables.

In some In accordance with another aspect of the present disclosure, an apparatus for data-driven prediction within a process simulation system is provided. The apparatus in some embodiments includes at least one processor and at least one non-transitory memory, the at least one non-transitory memory having computer-coded instructions stored thereon. The computer-coded instructions in execution with the at least one processor causes the apparatus to perform any of the example computer-implemented methods described herein. In some other embodiments, the apparatus includes means for performing each step of any of the computer-implemented methods described herein.

In accordance with another aspect of the present disclosure, a computer program product for data-driven prediction within a process simulation system is provided. The computer program product in some embodiments includes at least one non-transitory computer-readable storage medium having computer program code stored thereon. The computer program code in execution with at least one processor is configured for performing any one or the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with an example embodiment of the present disclosure;

FIG. 3 illustrates a visualization of an example data environment for data-driven prediction process in accordance with an example embodiment of the present disclosure;

FIG. 4 illustrates a visualization of an example data environment for training a data-driven model in accordance with an example embodiment of the present disclosure;

FIG. 5 illustrates a signal diagram of a data-driven prediction process in accordance with an example embodiment of the present disclosure; and

FIG. 6 illustrates a flowchart showing an example of a process for generating data-driven prediction within a process simulation system in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the present disclosure may be embodied in many different forms and should not be construed as limited to the embodiments set forth herein, rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure address technical challenges related to process simulation. Process simulation models may be configured for modelling and/or simulating process(es) associated with, for example, an industrial plant (e.g., gas processing plants, oil refineries, and/or the like). Such modelling and simulating may be used to monitor, control, and/or optimize process(es) of an industrial plant. However, some key process models that are key performance indicators for a process may not be readily modelled by first principles. In various environments and applications, not all key variables of a process can be measured in real time or otherwise fast enough to be used for optimization and/or process control. Moreover, not all key variables of a process can be derived directly from a first principles model.

Various embodiments of the present disclosure address several deficiencies related to process simulation, including the above deficiencies. Various embodiments of the present disclosure leverage a data-driven model to augment first principle model predictions. Various embodiments of the present disclosure integrate the data-driven model within a process simulation system to predict the values for target process variables that may not be readily measured in real-time or predicted using first principles. Various embodiments of the present disclosure integrate the data-driven model within a process simulation model using biased predictions of the process variables to capture various benefits of the predicted key process indicator. Various embodiments of the present disclosure utilize a data-driven model, such as a machine learning soft sensor model. Various embodiments of the present disclosure train the machine learning soft sensor model to generate predicted values for the target process variables based on process data provided as input to the machine learning soft sensor model.

By integrating a data-driven model within a process simulation system to augment first principles model, various embodiments of the present disclosure provide capabilities not available in conventional process simulation systems. Accordingly various embodiments, of the present disclosure improve process simulation technology. As one example, by integrating a data-driven model configured to predict values (e.g., measurements) for target process variables that may not be readily predicted using a first principles model, various embodiments of the present disclosure provide additional information that can be leveraged by a process simulation system and or an end-user to perform various actions, such as offline studies (e.g., engineering studies) and optimization calculations that, for example, utilize the target variables as a parameter. For instance, the predicted values for the target process variables may serve as constraints in offline studies and/or optimization calculations. Various embodiments of the present disclosure enable values of key performance indicators for a process to be predicted, for example between laboratory measurements, and include the predicted values in offline studies and/or optimization calculations. Moreover, by integrating a data-driven model configured to predict values (e.g., measurements) for target process variables that may not be readily predicted using a first principles model, various embodiments allow for the target process variables to be predicted as the process simulation model is perturbed during offline studies and/or optimization activities. Furthermore, by integrating a data-driven model configured to predict values (e.g., measurements) for target process variables that may not be readily predicted using a first principles model, various embodiments of the present disclosure maximize performance by enabling operating closer to desired target value(s). Accordingly various embodiments, of the present disclosure improve end-user efficiency, computing efficiency, and process simulation technology to name a few.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “industrial plant,” “plant,” and/or similar terms used herein interchangeably may refer to one or more buildings, complex, or arrangement of components that perform a chemical, physical, electrical, mechanical process, and/or the like for converting input materials into one or more output products. Non-limiting examples of an industrial plant include a chemical industrial plant, automotive manufacturing plant, distillery, oil refinery, fabric manufacturing plant, and/or the like.

The term “physical component” with respect to an industrial plant may refer to asset(s) within or associated with the industrial plant. Such assets, for example, may include real-world equipment, system, or other physical structure within and/or associated with the industrial plant, and that is utilized by the industrial plant. For example, a physical component with respect to an industrial plant may comprise equipment, system, or other structure that is utilized in a process performed by the industrial plant. In an example context of an oil refinery plant, non-limiting examples of a physical component may include a furnace, a pump, a heat exchanger, and/or the like.

The term “process simulation model” may refer to a model-based representation of one or more processes of an industrial plant. A process simulation model may be configured to facilitate designing, developing, analyzing, monitoring, controlling, optimizing, and/or the like one or more processes of the industrial plant. Such processes for example, may include chemical processes, biological processes, and/or the like. In one or more embodiments, a process simulation model embodies a flowsheet that describes the process flow through an industrial plant. Non-limiting examples of a process simulation model include first principles model, data-driven models, and hybrid simulation models.

The term “first principles model” may refer to a model-based representation of one or more processes of an industrial plant based on fundamental laws of physics, thermodynamics, kinetics, chemistry, etc. For example, a feed stream associated with a gas refrigeration plant may be defined in a first principles model in terms of its physical and/or chemical properties. As another example, a feed stream associated with a crude oil processing plant may be defined in a first principles model in terms of its physical and/or chemical properties. In some embodiments a first principles model is configured to generate model-predicted data that includes predicted values for one or more process variables associated with a process (e.g., of the industrial plant) represented in the first principles model. One or more inputs to a first principles model may be fixed input(s), while one or more inputs to the process simulation model may be variable input(s). Additionally or alternatively, one or more inputs to a first principles model may be a computed value, for example, by the first principles model and/or by a predictive model such as a machine learning model or artificial intelligent model. Additionally or alternatively, one or more inputs to the first principles model may comprise data received from the industrial plant whose process(es) is modeled by the first principles model. As a non-limiting example, such data received from an industrial plant may comprise process variable measurements (e.g., sensor-based measurements). In some examples, a first principles model may be configured for online simulation and/or offline simulation. In one or more embodiments, execution of a first principles model includes performing one or more operations. As a non-limiting example, the one or more operations may include an optimization operation with respect to one or more objective functions (e.g., minimum energy, maximum production, maximum profit, minimum cost, and/or the like) in order to determine optimal operating points/conditions for one or more output process variables. An optimal operating point/condition for an output process variable, for example, may describe a stable operating point/condition for the output process variable. In some embodiments, a first principles model may include a steady-state model or a dynamic model. For example, in some embodiments a first principles model may simulate a steady state process and/or a dynamic process. In some embodiments, a first principles model may be associated with or otherwise embodied by a digital twin model.

The term “data-driven model” may refer to a data entity that describes a model that is generated based on empirical data. In some example, the empirical data may be obtained from historical data, simulations, experiments, a combination thereof, and/or the like. A data-driven model may be configured to extract and/or determine correlations and/or patterns in input data to generate corresponding output. In some embodiments, a data-driven model may include a machine learning model. An example of a data-driven model is machine learning soft sensor model. In some embodiments a data-driven model, such as a machine learning soft sensor model is configured, trained, and/or the like to generate model-predicted data (e.g., data-driven model-predicted data) that includes predicted values for one or more target process variables. In some examples, the data-driven model may include one or more of any type of machine learning model including one or more supervised, unsupervised, semi-supervised, reinforcement learning models, and/or the like. In some examples, the data-driven model may include multiple models configured to perform one or more different stages of a prediction process. In some embodiments, the data-driven model includes a neural network, such as a recurrent neural network, deep neural network, and/or the like. In some examples, the data-driven model may include one or more neural networks that are previously trained, using one or more supervised and/or unsupervised machine learning techniques, to generate model-predicted data for one or more target process variables. In some embodiments, the data-driven model includes a regression model, such as a linear regression model, a partial least square regression model, a support vector regression model, and/or the like. In some examples, the data-driven model may include one or more regression models that are previously trained, using one or more supervised and/or unsupervised machine learning techniques, to generate model-predicted data for one or more target process variables.

The term “target process variable” may refer to a data entity that describes a process variable associated with a process of an industrial plant. In some examples a target process variable is a process variable that may not be readily measured in real time and/or may not be derived directly from a first principles model. For example, a target process variable may include a process variable whose measurements are determined periodically during plant operation using laboratory techniques (e.g., measured in a laboratory). In some examples, a target process variable may represent a key performance indicator associated with the process and/or the operation of the industrial plant as a whole. In one example, a predicted value for a target process variable may be generated using a data-driven model, such as a machine learning soft sensor model.

The term “model-predicted data” may refer to a data entity that describes output of a process simulation model, such as a first principles model and/or a data-driven model. Model-predicted data may include predicted values (e.g., predicted measurements) for one or more process variables. In some examples, the one or more process variables may include target process variables and/or other process variables. Examples of model-predicted data include first principles-driven model-predicted data generated by a first principles model, data-driven model predicted data generated by a data-driven model such as a machine learning soft sensor model, and/or the like.

The term “digital twin model” may refer to a digital, model-based representation of physical components (e.g., equipment, system, processes, etc.) in operation. In one or more embodiments, a digital twin model is configured to run with plant data in that incoming data (e.g., process data) from the plant is fed into the digital twin model to update the model. As such, a digital twin model may describe a representation of processes of an industrial plant that reflects the current operating conditions. A digital twin model may be used to monitor, refine, control, predict, and/or optimize operations of the industrial plant. In some embodiments, a digital twin model may include one or more of a first principles model and/or a data-driven model.

### Example Systems and Apparatuses

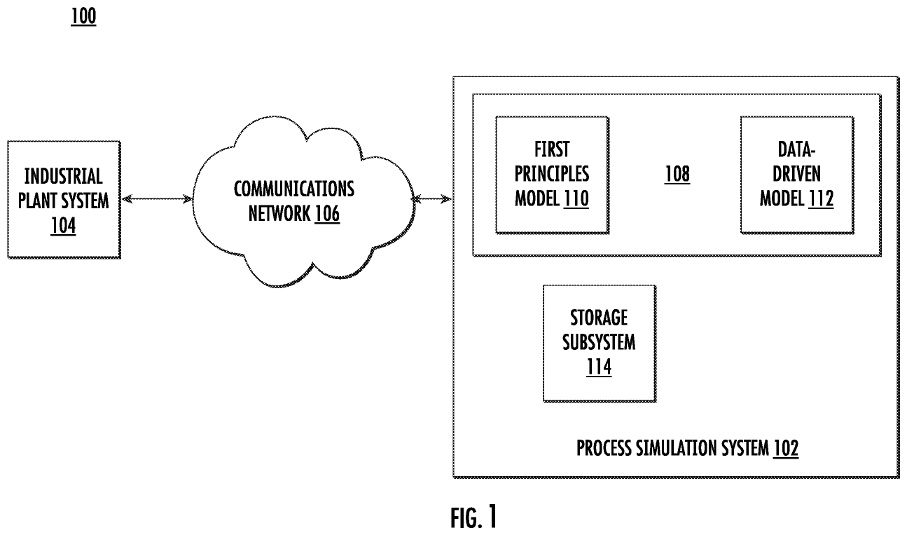

FIG. 1 illustrates a block diagram of an environment/system 100 in which embodiments of the present disclosure may operate. Specifically, FIG. 1 illustrates an industrial plant system 104 system in communication with a process simulation system 102. In some embodiments, the industrial plant system 104 communicates with the process simulation system 102 over one or more communication network(s), for example a communications network 106. In some embodiments, the industrial plant system 104 is in communication with a plurality of industrial plant systems, each identically or similarly configured to the industrial plant system 104. In some such embodiments, the process simulation system 102 may process data associated with each industrial plant system 104 independently, and/or in some contexts processes data associated with multiple industrial plant systems 104 in the aggregate (e.g., when processing all industrial plant system 104 associated with a particular entity, region, and/or the like).

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities are over the communications network 106 are altered and/or rendered unnecessary. For example, in some embodiments, the industrial plant system 104 includes some or all of the process simulation system 102, such that an external communications network 106 is not required.

In some embodiments, the industrial plant system 104 and the process simulation system 102 are embodied in an on-premises system within or associated with an industrial plant. In some such embodiments, the industrial plant system 104 and the process simulation system 102 are communicatively coupled via at least one wired connection. Alternatively or additionally, in some embodiments, the industrial plant system 104 embodies or includes the process simulation system 102, for example as a software component of a single enterprise terminal.

In some embodiments, the industrial plant system 104 includes any number of computing device(s), system(s), physical component(s), and/or the like, that facilitates producing of any number of products, for example utilizing particular configurations that cause processing of particular inputs available within the industrial plant system 104. In some embodiments, the industrial plant system 104 includes one or more physical component(s), connection(s) between physical component(s), and/or computing system(s) that control operation of each physical component therein. In some embodiments, a physical component includes asset(s) within or associated with an industrial plant associated with the industrial plant system 104. Such assets, for example, may include equipment, process, system, and/or the like within and/or associated with the industrial plant, and that is utilized by the industrial plant. For example, a physical component with respect to an industrial plant may comprise equipment, system, or other structure that is utilized in a process performed by the industrial plant. In an example context of an oil refinery plant, non-limiting examples of a physical component may include a furnace, a pump, a heat exchanger, and/or the like. The industrial plant system 104, for example, may embody or otherwise be associated with an industrial plant such as an oil refinery, an automotive engine manufacturing plant, a distillery, and/or the like, which includes physical component(s) that perform particular process(es) to alter properties of inputs to the component(s). Additionally or alternatively, in some embodiments the industrial plant system 104 includes one or more computing system(s) that are specially configured to operate the physical component(s) in a manner that produces one or more particular product(s), for example, simultaneously.

In some embodiments, an industrial plant system 104 includes one or more computing device(s) and/or system(s) embodied in hardware, software, firmware, and/or a combination thereof, that configure and/or otherwise control operation of one or more physical component(s) in the corresponding industrial plant(s). For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different industrial plant system(s) may include or otherwise be associated with different physical component(s), computing system(s), and/or the like.

In some embodiments, the industrial plant system 104 includes one or more client device(s), user device(s), and/or the like, that enable access to the functionality provided via the process simulation system 102, for example via a web application, a native application, and/or the like executed on the client device. In some embodiments, the industrial plant system 104 includes or embodies a display or other user interface to which a user-facing interface is renderable.

In some embodiments, the process simulation system 102 includes one or more application server(s) and/or database server(s) that provide such functionality. Additionally or alternatively, in some embodiments, the process simulation system 102 includes one or more client device(s), user device(s), and/or the like, that enable access to the functionality provided via the process simulation system 102, for example via a web application, a native application, and/or the like executed on the client device. In some embodiments, the process simulation system 102 includes or embodies a display or other user interface to which a user-facing interface is renderable.

In some embodiments, the process simulation system 102 includes one or more computing device(s) and/or system(s) embodied in hardware, software, firmware, and/or a combination thereof, that can model and/or simulate process(es) associated with an industrial plant, such as an industrial plant associated with industrial plant system 104. In some embodiments, the process simulation system 102 includes one or more specially configured application server(s), database server(s), end user device(s), cloud computing system(s), and/or the like. Additionally or alternatively, in some embodiments, the process simulation system 102 includes one or more user device(s) that enables access to functionality provided by the process simulation system 102, for example via a web application, native application, and/or the like. For example, in some embodiments, the process simulation system 102 provides cloud-based functionality to an end-user that facilitates cloud-based monitoring, controlling, optimization, etc., of physical component(s) (e.g., equipment, process(es), and/or the like) associated with an industrial plant embodied by the industrial plant system 104.

In some embodiments, the process simulation system 102 includes a storage subsystem 114. In some embodiments, the storage subsystem 114 is internal to the process simulation system 102. In some embodiments, the storage subsystem 114 is external to the process simulation system 102. For example, in some embodiments, the storage subsystem 114 may comprise a part of a separate system in communication with the process simulation system 102 (e.g., via the communications network 106).

In some embodiments, the process simulation system 102, is configured to perform, based at least in part on input data (e.g., process data) associated with the operation of the industrial plant and utilizing one or more models, one or more modeling operations and/or simulation operations to generate model-predicted data. In some embodiments, the model-predicted data includes data that represents or otherwise is indicative of predicted values (e.g., measurements) for one or more process variables associated with operation of an industrial plant embodied by the industrial plant system 104 and whose process(es) is modeled within the process simulation system 102. Additionally or alternatively, in some embodiments, model-predicted data includes data indicative of operating points/condition(s) for one or more process variables associated with operation of an industrial plant embodied by the industrial plant system 104 and whose process(es) is modeled within the process simulation system 102. Additionally or alternatively, in some embodiments, model-predicted data includes data that represents or is otherwise indicative of predicted optimal operating points/conditions for one or more process variables associated with operation of an industrial plant embodied by the industrial plant system 104 and whose process(es) is modeled within the process simulation system 102. Additionally or alternatively, in some embodiments, the model-predicted data includes data that represents or is otherwise indicative of one or more of predicted plant performance measure. In some embodiments, the model-predicted data includes a first model-predicted data and a second model-predicted data. For example, the model predicted data may include first principles-driven model-predicted data (e.g., first model-predicted data) and data-driven model-predicted data (e.g., second model-predicted data)

In some embodiments, the process simulation system 102 and/or the model-predicted data output thereof may be leveraged for designing, analyzing, monitoring, controlling, and/or optimizing various operations of an industrial plant associated with the industrial plant system 104. As a non-limiting example, the process simulation system 102 may be used for optimization based on one or more optimization objective functions and/or constraints in order to determine optimal operating points/conditions for specified variables. In some examples, non-limiting examples of such optimization object functions may include minimum energy objective function, maximum production objective function, maximum profit objective function, minimum cost objective function, and/or the like. In some examples, non-limiting examples of constraints with respect to an optimization calculations include physical equipment limits constraint, safe operating limits constraints, product quality specifications constraints, product flows (minimum or maximum limits) constraints, energy use constraints, feed availability constraints, and/or the like. In some embodiments, an optimal operating point/condition for a specified process variable describes a stable operating point/condition for the specified process variable. As a non-limiting example, the process simulation system 102 may be used for engineering studies.

In some embodiments, the process simulation system 102 and the industrial plant system 104 communicate with one another to perform the various actions described herein. For example, in some embodiments, the process simulation system 102 and the industrial plant system 104 communicate in order to generate model-predicted data associated with operation of an industrial plant embodied by the industrial plant system 104. Additionally or alternatively, in some embodiments, the process simulation system 102 and the industrial plant system 104 communicate to facilitate control or adjustment of operation of physical component(s) within or associated with the industrial plant based at least in part on the generated model-predicted data. For example, in some embodiments, the process simulation system 102 and the industrial plant system 104 can communicate to automatically configure or reconfigure one or more physical component(s) of the industrial plant based on the model-predicted data.

In some embodiments, the process simulation system 102 includes a process simulation model 108 that is configured to perform various functionalities associated with the process simulation system 102 as described herein. For example, in some embodiments, the process simulation system 102 leverages the process simulation model 108 to perform various functionalities associated with modeling and simulating process(es) of an industrial plant associated with industrial plant system 104. As another example, in some embodiments, the process simulation system 102 leverages the process simulation model 108 to generate model-predicted data. As yet another example, in some embodiments, the process simulation system 102 leverages the process simulation model 108 to perform engineering studies, optimization calculations, and/or the like.

In some embodiments, the process simulation model 108 includes one or more of a first principles model 110 and a data-driven model 112. In some embodiments, the data-driven model 112 is configured to supplement/augment the first principles model 110. In some embodiments, the process simulation model 108 includes one or more first principles model 110 and one or more data-driven model 112.

In some embodiments, the first principles model 110 is configured to perform various functionalities associated with the process simulation system 102. In some embodiments, a first principles model is a model-based representation of one or more assets (e.g., equipment and/or processes and/or their units) of an industrial plant based on fundamental laws of physics, thermodynamics, kinetics, chemistry, and/or the like. A first principles model may be generated based on underlying physics, thermodynamic, kinetics, chemistry, etc., of equipment and/or process(es) modeled by the first principles model. In some embodiments, the first principles model 110 is configured to model one or more processes of an industrial plant associated with the industrial plant system 104. In some embodiments, a first principles model 110 may include a steady-state model or a dynamic model in that the first principles model 110 may be a steady state representation or dynamic representation of process(es) of an industrial plant. In some embodiments, the first principles model 110 may be supplemented/augmented with one or more data-driven models.

In one or more embodiments, the first principles model 110 and/or the process simulation system 102 embodies a flowsheet that represents the process flow through the industrial plant. In some embodiments, a flowsheet can define asset models and their associated properties utilized by the process simulation system 102 (e.g., the first principles model 110 thereof) to perform process simulation. In some embodiments, a flowsheet is configured to model relationships between processes of the plant. A flowsheet model, for example, may relate individual equipment (e.g., pumps, heat exchangers, distillation unit, etc.) to performance variables (e.g., key performance indicators) of overall plant process. In some embodiments, the first principles model 110 is configured perform one or more of its calculations (e.g., implement one or more algorithms) within the flowsheet.

In some embodiments, the first principles model 110 is configured to implement one or more specially configured algorithms based on inter-related asset models for an industrial plant associated with the industrial plant system 104. In some embodiments, the first principles model 110 is configured to implement the one or more specially configured algorithms to simulate process(es) of the industrial plant represented (e.g., modeled) in the first principles model 110. Additionally or alternatively, the first principles model 110 may be configured to implement one or more specially configured algorithms to generate model-predicted data.

As described in relation to the process simulation system 102, in some embodiments, model-predicted data include data that represents or otherwise is indicative of predicted values (e.g., measurements) for one or more process variables associated with operation of an industrial plant embodied by the industrial plant system 104 and whose process(es) is modeled within the process simulation system 102. Additionally or alternatively, in some embodiments, model-predicted data includes data indicative of operating points/condition(s) for one or more process variables associated with operation of an industrial plant embodied by the industrial plant system 104 and whose process(es) is modeled within the process simulation system 102. Additionally or alternatively, in some embodiments, model-predicted data includes data that represents or is otherwise indicative of predicted optimal operating points/conditions for one or more process variables associated with operation of an industrial plant embodied by the industrial plant system 104 and whose process(es) is modeled within the process simulation system 102. Additionally or alternatively, in some embodiments, the model-predicted data includes data that represents of is otherwise indicative of one or more of predicted plant performance measure. Additionally or alternative, in some embodiments, the model-predicted data include data that represents or is otherwise indicative of comparison results of current plant performance against historical plant performance.

In some embodiments, one or more inputs for the first principles model 110 may be fixed input(s), while one or more inputs for the first principles model 110 may be variable input(s). Additionally or alternatively, one or more inputs for the first principles model 110 may be a computed value. In one or more embodiments, an input for the first principles model 110 that is a computed value is determined (e.g., computed) by the first principles model 110 and/or determined (e.g., computed) by a data-driven model 112. Additionally or alternatively, one or more inputs for the first principles model 110 may include process data (e.g., plant data) received from the industrial plant system 104. In some embodiments, process data includes values (e.g., measurements) for one or more selected process variables. Non-limiting examples of process variables may include temperature, feed flow, pressure, and/or the like. In some examples, one or more equipment and/or processes associated with the industrial plant system 104 may include sensor device(s) for measuring and/or providing a portion of the input data (e.g., feed flow, temperature, pressure, and/or the like) for the first principles model 110. In some examples, a portion of the input data is measured in near real-time and provided to the first principles model in near real-time. In some examples, a portion of the input data may include values for process variables that are periodically measured during plant operating using laboratory techniques (e.g., measured in a laboratory).

In some embodiments, the data-driven model 112 is configured to perform various functionalities associated with the process simulation system 102. In some embodiments, a data-driven model describes a model that is generated based on empirical data. The empirical data may be obtained from historical data, simulations, experiments, a combination thereof, and/or the like. In some embodiments, the data-driven model is a machine learning soft sensor model. A data-driven model, such as a machine learning soft sensor model may be configured to extract and/or determine correlations and/or patterns in input dataset to generate corresponding output. In some embodiments, a data-driven model may include a machine learning model. In some embodiments, a machine learning model describes parameters, hyper-parameters, and/or defined operations of a rules-based algorithm and/or machine learning model (e.g., model including at least one or more rule-based layers, one or more layers that depend on trained parameters, coefficients, and/or the like). In some embodiments, the data-driven model 112 (e.g., machine learning soft sensor model) may include one or more of any type of machine learning model including one or more supervised, unsupervised, semi-supervised, reinforcement learning models, and/or the like. In some examples, the data-driven model 112 may include multiple models configured to perform one or more different stages of a prediction process. In some embodiments, the data-driven model 112 includes a neural network, such as a recurrent neural network, deep neural network, and/or the like. In some examples, the data-driven model may include one or more neural networks that are previously trained, using one or more supervised and/or unsupervised machine learning techniques, to generate a prediction for a first principles model, such as first principles model 110. In some embodiments, the data-driven model 112 includes a regression model, such as a linear regression model, a partial least square regression model, a support vector regression model, and/or the like. In some examples, the data-driven model may include one or more regression models that are previously trained, using one or more supervised and/or unsupervised machine learning techniques, to generate a prediction for a first principles model, such as first principles model 110.

In some embodiments, the data-driven model 112 is configured, trained, and/or the like to generate model-predicted data for one or more target process variables. In some embodiments, a target process variable is a data entity that describes a process variable associated with a process of an industrial plant, and that may not be readily measured in real time and/or may not be derived directly from a first principles model. For example, a target process variable may include a process variable whose measurements are determined periodically during plant operation using laboratory techniques (e.g., measured in a laboratory). In some examples, a target process variable may represent a key performance indicator associated with the process and/or the operation of the industrial plant as a whole. In some embodiments, the data-driven model 112 is configured to supplement/augment the first principles model 110.

In some embodiments, the first principles model 110 and/or the data-driven model 112 may represent a digital twin (e.g., digital twin model) of an industrial plant associated with the industrial plant system 104. In some embodiments, a digital twin model may describe a model-based representation of physical components (e.g., equipment, system, processes, etc.) in operation. The digital twin model may be configured to run with plant data in that incoming data from the plant is fed into the digital twin model to update the model. As described above, plant data (e.g., process data) may include measurements of one or more measured process variables. In some embodiments, the one or more process variables may include equipment variable(s) (e.g., equipment variable measurements associated with a process). As such, a digital twin model may describe at least in part a representation of equipment and/or processes of an industrial plant that reflects the current operating conditions, and may be used to monitor, refine, control, predict, and/or optimize operations of the industrial plant. Additionally or alternatively, the digital twin model may be used to collect and store various data associated with the operation of the industrial plant.

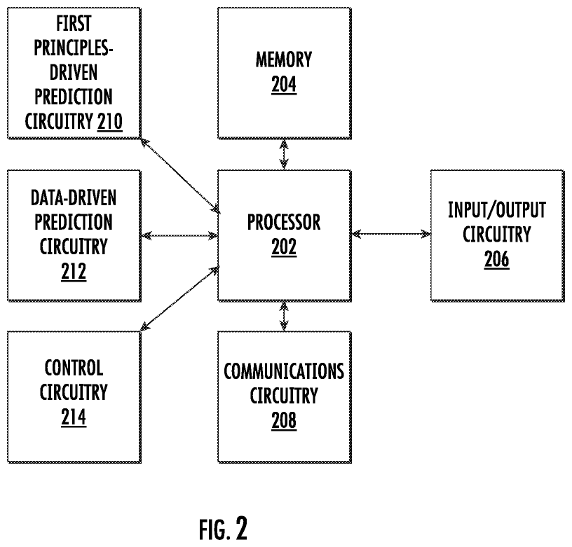

FIG. 2 illustrates a block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. In some embodiments, the intelligent process modeling and simulation system 102, and/or a portion thereof is embodied by one or more system(s), such as the apparatus 200 as depicted and described in FIG. 2. The apparatus 200 includes processor 202, memory 204, input/output circuitry 206, communications circuitry 208, first principles-driven prediction circuitry 210, data-driven prediction circuitry 212, and optional control circuitry 214. In some embodiments, the apparatus 200 is configured, using one or more of the sets of circuitry 202-214 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with the process simulation system 102. For example, in the one particular example embodiments, the processor 202 is configured to perform various operations associated with the first principles model 110 and/or the data-driven model 112. In some embodiments, the processor 202 includes hardware, software, firmware, and/or a combination thereof, for implementing one or more algorithms to model and/or simulate the execution of defined process(es) within the process simulation system 102, for example, based on inter-related asset models associated with the industrial plant system 104. For example, in some embodiments, the processor 202 includes hardware, software, firmware, and/or a combination thereof, for performing a variety of calculations associated with the first principles model 110 and/or the data-driven model 112. In some embodiments, the processor 202 can facilitate storing, sending and/or receiving data associated with the execution of the first principles model 110 and/or the data-driven model 112 among various components of the system 100.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the first principles-driven prediction circuitry 210 includes hardware, software, firmware, and/or a combination thereof, configured to perform various functionalities associated with the process simulation system 102. In some embodiments, the first principles-driven prediction circuitry 210 includes hardware, software, firmware, and/or a combination thereof, that is configured to support configuration and/or generation of the first principles model 110. Additionally or alternatively, in some embodiments, the first principles-driven prediction circuitry 210 includes hardware, software, firmware, and/or a combination thereof, that is configured to support fine-tuning, validating, and/or updating the first principles model 110.

In some embodiments, the first principles-driven prediction circuitry 210 includes hardware, software, firmware, and/or a combination thereof, that is configured to leverage the first principles model 110 to model one or more processes associated with the industrial plant system 104 (e.g., one or more processes of an industrial plant associated with the industrial plant system 104). In some embodiments, the first principles-driven prediction circuitry 210 includes hardware, software, firmware, and/or a combination thereof, configured to leverage the first principles model 110 to perform one or more calculations to simulate the execution of defined process(es) (e.g., process(es) of the industrial plant that is modeled/represented in the first principles model 110). In some embodiments, the execution of the defined processes is simulated to generate model-predicted data (e.g., first principles-driven model-predicted data). In some embodiments, a portion of the one or more calculations is performed within a flowsheet maintained by the process simulation system 102 and/or the first principles model 110. In some embodiments, the first principles-driven prediction circuitry 210 is configured to leverage the first principles model 110 to perform one or more of steady-state simulation and/or dynamic simulation.

In some embodiments, the first principles-driven prediction circuitry 210 includes hardware, software, firmware, and/or a combination thereof, that is configured to receive, store, and/or maintain input data leveraged by the first principles model 110 to simulate execution of defined process(es) and/or to generate model-predicted data. In some embodiments, the first principles-driven prediction circuitry 210 receives at least a portion of the input data from the industrial plant system 104. In some embodiments, the input data includes plant data (e.g., process data for the plant) associated with the process(es) represented in the first principles model 110. The plant data, for example, may include measurements for one or more process variables represented in the first principles model 110. For example, one or more processes of the plant may include sensor(s) configured for measuring process variable(s). Additionally or alternatively, in some embodiments, the input data may include simulated data. It would be appreciated that the input data may include other data, and may not be limited to plant data or simulated data. In some embodiments, the first principles-driven prediction circuitry 210 includes hardware, software, firmware, and/or a combination thereof, that is configured to provide the input data to the first principles model 110 to facilitate simulating the execution of a process represented in the first principles model 110 in order to generate model-predicted data that includes predicted values for one or more process variables associated with modeled process. In some embodiments, the first principles-driven prediction circuitry 210 includes a separate processor, specially configured field programmable gate array (FPGA), or a specially programmed application specific integrated circuit (ASIC).

In some embodiments, the data-driven prediction circuitry 212 includes hardware, software, firmware, and/or a combination thereof, that is configured to performs various functionalities associated with the process simulation system 102. In some embodiments, the data-driven prediction circuitry 212 includes hardware, software, firmware, and/or a combination thereof, that is configured to support configuration and/or generation of the data-driven model 112. Additionally or alternatively, in some embodiments, the data-driven prediction circuitry 212 includes hardware, software, firmware, and/or a combination thereof, that is configured to support training, fine-tuning, validating, updating, and/or re-training the data-driven model 112.

In some embodiments, the data-driven prediction circuitry 212 includes hardware, software, firmware, and/or a combination thereof, that is configured to implement one or more specially configured algorithms to generate one or more predictions. In some embodiments, the one or more predictions includes model-predicted data that includes predicted values for one or more target process variables. In some embodiments, the data-driven prediction circuitry 212 includes hardware, software, firmware, and/or a combination thereof, that is configured to receive, store, and/or maintain input data leveraged by the data-driven model 112 to generate data-driven model-predicted data. In some embodiments, the input data includes plant data (e.g., process data for the plant) associated with the process(es) represented in the data-driven model 112. In some embodiments, a process represented in the data-driven model may also be represented in the first principles model 110. Additionally or alternatively, in some embodiments, the input data may include simulated data. It would be appreciated that the input data may include other data, and may not be limited to plant data or simulated data. In some embodiments, the data-driven prediction circuitry 212 is configured to facilitate execution of one or more calculations associated with the data-driven model 112. In some embodiments, the one or more calculations may be performed within a flowsheet maintained by the process simulation system 102 and/or the first principles model 110.

In some embodiments, the data-driven prediction circuitry 212 is associated with a training phase and a prediction phase, wherein the data-driven model 112 is configured based at least in part on a training process and a prediction process. In some embodiments, the data-driven prediction circuitry 212 includes hardware, software, firmware, and/or a combination thereof, that is configured to cause the data-driven model 112 to undergo a training process using a training dataset. The data-driven prediction circuitry 212 may cause the data-driven model 112 to be trained to generate predictions associated with a first principles model 110 by learning based on the training dataset. In some embodiments, training the data-driven model 112 to generate predictions associated with a first principles models 110 includes applying one or more machine learning techniques based on the training dataset.

In some embodiments, the data-driven prediction circuitry 212 includes hardware, software, firmware, and/or a combination thereof, that is configured to provide the training dataset to the data-driven model 112. In some embodiments, the training dataset input into the data-driven model 112 may include a plurality of sets of historical process data and corresponding ground truth data for the one or more target process variables. In some embodiments, the historical process data in each set of historical process data and corresponding ground truth data includes one or more of (i) historical predicted values for the one or more target process variables or (ii) historical values for the one or more measured process variables.

In some embodiments, the data-driven prediction circuitry 212 may cause the data-driven model to undergo a training process using the training dataset in order to identify features and/or to determine optimal coefficients. The optimal coefficients may represent adjustment or weights to apply with respect to the features in order to produce data-driven model-predicted data reflected in the training dataset, for example, based on positive and/or negative correlations between extracted features from historical process data and extracted features from historical ground-truth data (e.g., actual laboratory measurements) corresponding to the historical process data. As such, in some example, the weights for the data-driven model 112 may be generated during a training phase of the data-driven model 112. In some embodiments, the data-driven prediction circuitry 212 includes a separate processor, specially configured field programmable gate array (FPGA), or a specially programmed application specific integrated circuit (ASIC).

In some embodiments, the optional control circuitry 214 includes hardware, software, firmware, and/or a combination thereof, that supports various functionality associated with causing configuration or causing other operation of at least one physical component (e.g., processing equipment, devices, systems, etc.) associated with the industrial plant system 104 (e.g., plant thereof). For example, in some embodiments, the optional control circuitry 214 includes hardware, software, firmware, and/or a combination thereof, that facilitates and/or causes automatic reconfiguration of the operation of at least one physical component based at least in part on the output of the process simulation system 102, the first principles model 110 and/or the data-driven model 112. In some embodiments, the optional control circuitry 214 includes a separate processor, specially configured field programmable gate array (FPGA), or a specially programmed application specific integrated circuit (ASIC).

### Example Data Environments and Architectures of the Disclosure

Having described example systems and apparatuses of the disclosure, example data architectures, data environments, and data flows will now be described. In some embodiments, the data architectures represent data object(s) maintained and processed in particular computing environments. In some embodiments, the computing environment(s) is/are maintained via hardware, software, firmware, and/or a combination thereof, that execute one or more software application(s) that manage such data. For example, in some embodiments, the apparatus 200 executes one or more software application(s) that maintain the data architecture(s) as depicted and described to, perform the functionality as depicted and described with respect to generation of data-driven predictions within a process simulation system.

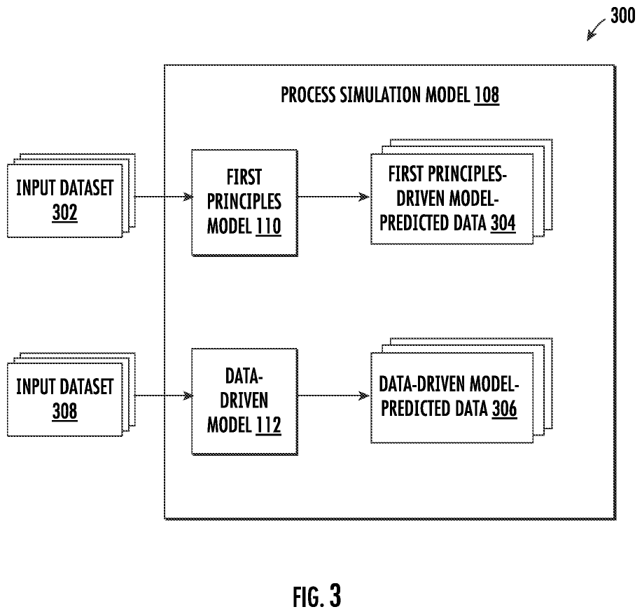

FIG. 3 illustrates a visualization of an example data environment for generating data-driven predictions within a process simulation system in accordance with an example embodiment of the present disclosure in accordance with at least one embodiment of the present disclosure. Specifically, the data environment for generating the data-driven predictions is performed by the process simulation system 102 using a process simulation model 108 that includes at least a data-driven model 112. In some embodiments, the process simulation model 108 also includes a first principles model 110. In some embodiments, the process simulation system 102 is embodied by the apparatus 200 as depicted and described herein. In some embodiments, the process simulation system 102 causes rendering of, or otherwise provides access to, one or more user interfaces specially configured to enable inputting data.

In some embodiments, an input dataset 302 is provided as input to the first principles model 110. In some embodiments, the input dataset 302 is received from the industrial plant system 104. In some embodiments, the input dataset 302 is received from a client computing entity associated with the industrial plant system 104. In some embodiments, the input dataset 302 includes one or more values for one or more process variables, such as measurements for the one or more process variables. In some embodiments, the one or more process variables correspond to one or more parameters for the first principles model 110. For example, in some embodiments, the first principles model 110 includes one or more variable parameters, where at least a portion of the input dataset includes values for the one or more parameters. Additionally or alternatively, in some embodiments, the first principles model 110 includes one or more fixed parameters (e.g., one or more parameters having a fixed value). In some embodiments, the input dataset 302 includes values for one or more variable parameters of the first principles model 110. In some embodiments, the value for one or more variable parameters of the first principles model 110 is configured to be generated by the first principles model 110, for example, based at least in part on a portion of the input dataset 302. Additionally or alternatively, in some embodiments, one or more variable parameters of the first principles model 110 may be configured to be generated by a predictive model and provided to the first principles model 110. The predictive model, for example, may include a machine learning model that is trained to generate values for the one or more variable parameters based on the input dataset. In some embodiments, the predictive model may include a data-driven model such as data-driven model 112.

In some embodiments, upon receiving the input dataset 302, the first principles model 110 performs data transformation, processing, modeling, simulations, and/or the like based on the input data to generate first principles-driven model-predicted data 304. In some embodiments, the first principles model 110 executes one or more specially configured algorithms to generate the first principles-driven model-predicted data 304. In some embodiments, the first principles-driven model-predicted data 304 includes predicted values (e.g., measurements) for one or more process variables. In some embodiments, the one or more process variables may represent key performance indicators associated with the operation of an industrial plant whose process(es) is modeled by the first principles model 110

In some embodiments, the first principles-driven model-predicted data 304 is stored in one or more repository accessible to the process simulation system 102 and/or an end user, such that the first principles-driven model-predicted data 304 may be accessed, browsed, searched, and/or otherwise identified and selected for use. For example, first principles-driven model-predicted data 304 stored in the one or more repository may be retrieved and used to train, fine-tune, re-train, validate, and/or update a data-driven model, such as data-driven model 112.

In some embodiments, an input dataset 308 is provided as input to the data-driven model 112. In some embodiments, the input dataset 308 is received from the industrial plant system 104. In some embodiments, the input dataset 308 is received from a client computing entity associated with the industrial plant system 104. In some embodiments, the input dataset 302 is the same as the input dataset 308 received by the data-driven model 112 received by the first principles model 110. In some embodiments, the input dataset 302 received by the data-driven model 112 is different from the input dataset 308 received by the first principles model 110. In some embodiments the input dataset 308 is a subset of the input dataset 302.

In some embodiments, the input dataset 308 includes one or more values for one or more process variables, such as measurements for the one or more process variables. In some embodiments, the one or more process variables correspond to one or more parameters for the data-driven model 112. For example, in some embodiments, the data-driven model 112 includes one or more variable parameters, where at least a portion of the input dataset 308 includes values for the one or more parameters. Additionally or alternatively, in some embodiments, the data-driven model 112 includes one or more fixed parameters (e.g., one or more parameters having a fixed value). In some embodiments, the input dataset includes values for one or more variable parameters of the data-driven model 112. In some embodiments, the value for one or more variable parameters of the data-driven model 112 is configured to be generated by the data-driven model 112, for example, based at least in part on a portion of the input dataset 308

In some embodiments, upon receiving the input dataset 308, the data-driven model 112 performs data transformation, processing, modeling, simulations, and/or the like based on the input dataset 308 to generate data-driven model-predicted data 306 for one or more target process variables. In some embodiments, the data-driven model 112 executes one or more specially configured algorithms to generate the data-driven model-predicted data 306. In some embodiments, the data-driven model 112 may be configured to extract and/or determine correlations and/or patterns in the input dataset 302 to generate data-driven model-predicted data 306 for the one or more target process variables In some embodiments, a data-driven model may include a machine learning model. In some embodiments, the data-driven model is a machine learning soft sensor model. In some embodiments, a machine learning model describes parameters, hyper-parameters, and/or defined operations of a rules-based algorithm and/or machine learning model (e.g., model including at least one or more rule-based layers, one or more layers that depend on trained parameters, coefficients, and/or the like). In some embodiments, the data-driven model 112 (e.g., machine learning soft sensor model) may include one or more of any type of machine learning model including one or more supervised, unsupervised, semi-supervised, reinforcement learning models, and/or the like. In some examples, the data-driven model 112 may include multiple models configured to perform one or more different stages of a prediction process.

In some embodiments, the data-driven model-predicted data 306 output of the data-driven model 112 is stored in one or more repository accessible to the process simulation system 102 and/or an end user, such that the data-driven model-predicted data 306 may be accessed, browsed, searched, and/or otherwise identified and selected for use. For example, the data-driven model-predicted data 306 may be utilized for re-training, fine-tuning, refining, and/or updating the data-driven model 112. As another example, the data-driven model-predicted data 306 may be utilized as constraints in offline studies (e.g., engineering studies), optimization calculations, etc. As such, in some embodiments, the data-driven model-predicted data 306 output may be leveraged in the execution of one or more offline operations, such as engineering studies, optimization operations, and/or the like.

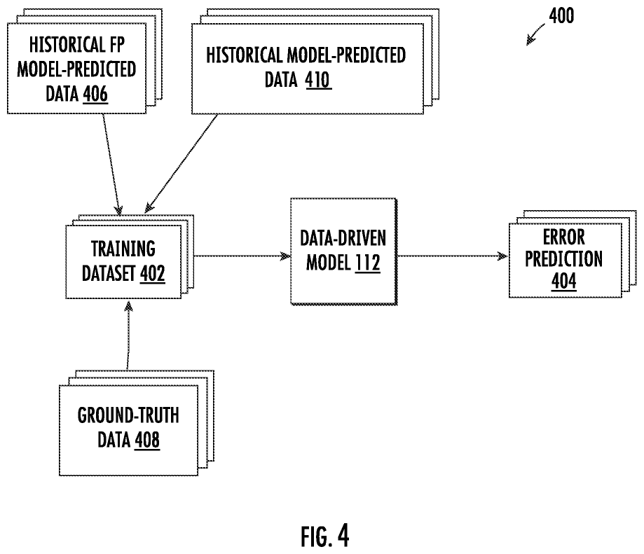

As described above, in some embodiments, the data-driven model 112 is previously trained using one or more training techniques. An operational example of training a data-driven model will now further be described with reference to FIG. 4.

FIG. 4 illustrates a visualization of an example data environment for training a data-driven model in accordance with at least one embodiment of the present disclosure. Specifically, the data environment for training the data-driven model may be performed by the process simulation system 102. In some embodiments, the process simulation system 102 is embodied by the apparatus 200 as depicted and described herein. In some embodiments, the process simulation system 102 causes rendering of, or otherwise provides access to, one or more user interfaces specially configured to enable inputting of particular data portions.

In some embodiments, the data-driven model 112 is a machine learning soft sensor model. In some embodiments, the data-driven model 112 (e.g., machine learning soft sensor model) includes a neural network, such as a recurrent neural network, deep neural network, and/or the like. In some examples, the data-driven model may include one or more neural networks that are previously trained, using one or more supervised and/or unsupervised machine learning techniques, to generate data-driven model predictions (e.g., data-driven model-predicted data). In some embodiments, the data-driven model 112 includes a regression model, such as a linear regression model, a partial least square regression model, a support vector regression model, and/or the like. In some examples, the data-driven model may include one or more regression models that are previously trained, using one or more supervised and/or unsupervised machine learning techniques, to generate data-driven model predictions (e.g., data-driven model-predicted data).

FIG. 4 depicts an example training dataset 402. The training dataset 402 may be provided as input to the data-driven model 112 to train the data-driven model 112. In some embodiments, the training dataset 402 includes historical process data 406 and corresponding ground-truth data 408 (e.g., actual plant measurement) for target process variable(s). In some embodiments, the training dataset 402 may also include historical model-predicted data 410. In some embodiments, the historical model-predicted data 410 may include historical data-driven model predicted data corresponding to the historical process data 406. Additionally or alternatively, in some embodiments, the historical model-predicted data 410 may include historical first principles-driven model-predicted data corresponding to the historical process data. In some embodiments, the process simulation system 102 may be configured to retrieve the historical process data 406, the ground-truth data 408, and/or the historical model-predicted data 410 from one or more repositories. In some embodiments, the one or more repositories include storage subsystem 114.

Upon receiving the training dataset 402, the data-driven model 112 undergoes a training process. In some embodiments, the training process include extracting, determining, and/or learning correlations, relationships, and/or patterns in the training dataset 402. In some embodiments, training the data-driven model, includes executing a plurality of simulation scenarios under difference operating conditions. For example, in some embodiments, each simulation scenario is associated with a set of one or more operating conditions of a plurality of sets of one or more operating conditions.

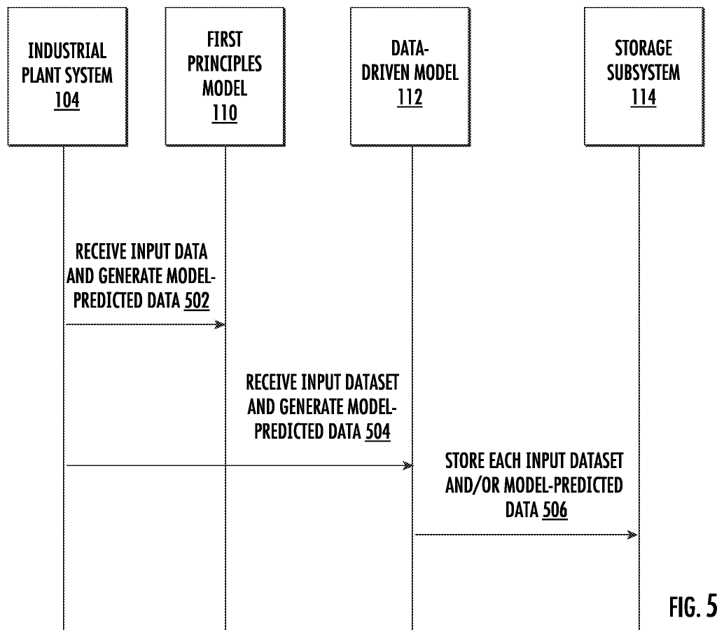

FIG. 5 illustrates a signal diagram of a data-driven prediction process in accordance with an example embodiment of the present disclosure. As depicted in FIG. 5, a first principles model 110 receives 502 an input dataset and the data-driven model 112 receive 504 an input dataset that may or may not be the same as the input dataset received by the first principles model 110. In some embodiments, the input dataset received by each of the first principles model 110 and the data-driven model 112 is associated with the operation of an industrial plant (e.g., an industrial plant associated with the industrial plant system 104) whose process(es) is modeled in the first principles model 110. In some embodiments, the input dataset received by the first principles model 110 includes one or more values for one or more process variables associated with the industrial plant. In some embodiments, the input dataset received by the data-driven model 112 include one or more values for one or more process variables associated the industrial plant. For example, the input dataset may include measurements for the one or more process variables associated with the process(es) represented in the first principles model 110 and/or the data-driven model 112.

In some embodiments, upon receiving the corresponding input dataset, the first principles model 110 performs data transformation, processing, modeling, simulations, and/or the like based on the input dataset to generate first principles-driven model-predicted data for one or more process variables. In some embodiments, upon receiving the corresponding input dataset, the data-driven model 112 performs data transformation, processing, modeling, simulations, and/or the like based on the input dataset to generate data-driven model-predicted data for one or more target process variables.

In some embodiments, each input dataset, first principles-driven model-predicted data and/or data-driven model predicted data are stored 506 in a repository, such as storage subsystem 114.

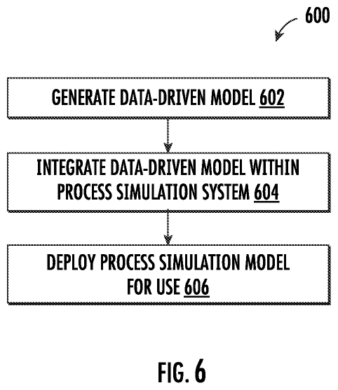

FIG. 6 illustrates a flowchart including example operations of an example process for model generating data-driven predictions within a process simulation system Specifically, FIG. 6 illustrates an example computer-implemented process 600. In some embodiments, the process 600 is embodied by computer program code stored on a non-transitory computer-readable storage medium of a computer program product configured for execution to perform the process as depicted and described. Alternatively or additionally, in some embodiments, the process 600 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate physical component(s) of one or more industrial plants, and/or the like. For purposes of simplifying the description, the process 600 is described as performed by and from the perspective of the apparatus 200.

At block 602, the apparatus 200 includes first principles-driven prediction circuitry 210, data-driven prediction circuitry 212, optional control circuitry 214, communications circuitry 208, input/output circuitry 206, processor 202, and/or the like, or a combination thereof, that generates, based on a training dataset, a data-driven model configured to output first model-predicted data (e.g., data-driven historical Model-predicted data) associated with at least one process of an industrial plant. In some embodiments, the data-driven model can be generated internally with respect to the first principles model (e.g., in a first principles model application) or externally (e.g., in specialist data science application). In some embodiments, generating the data-driven model includes determining training datasets for configuring, training, and/or validating the data-driven model. In some embodiments, multiple training datasets are considered and screened for their applicability. In some embodiments, generating the data-driven model includes selecting the data-driven model form (e.g., linear regression, partial least squares regression, support vector regression, gaussian process modeling, neural network, deep neural network and/or other algorithm types). In some embodiments, the training dataset is leveraged to determine the data-driven model parameters. In some embodiments, multiple validation datasets are used to validate the generated data-driven model. In some embodiments, the validation datasets may include a portion of the training dataset. In some embodiments, the first model-predicted data comprise a predicted value for each of one or more target process variables associated with the at least one process. The one or more target process variable may include process variable(s) that may not be readily measured in real time and/or may not be derivable directly from a first principles model. For example, a target process variable may include a process variable whose measurements are determined periodically during plant operation using laboratory techniques (e.g., measured in a laboratory). In some examples, a target process variable may represent a key performance indicator associated with the process and/or the operation of the industrial plant as a whole.

In some embodiments, the training dataset includes a plurality of sets of historical process data and corresponding ground truth data for the one or more target process variables. In some embodiments, the historical process data in each set of historical process data and corresponding ground truth data comprises one or more of historical predicted values for the one or more target process variables or historical values for a set of measured process variables. In some embodiments, generating the data-driven model include training the data-driven model to extract, determine, and/or learn correlations, relationships, and/or patterns in the training dataset 402. For example, in some embodiments, the data-driven model is trained to learn correlations, relationships, and/or patterns within the set of measured process variables and relate the correlations, relationships, and/or patterns to the one or more target process variables to generate values for the one more target process variables.

At block 604, the apparatus 200 includes first principles-driven prediction circuitry 210, data-driven prediction circuitry 212, optional control circuitry 214, communications circuitry 208, input/output circuitry 206, processor 202, and/or the like, or a combination thereof, that integrates the data-driven model within a process simulation model. For example, in some embodiments, the data-driven model is embedded within the process simulation model. In some embodiments the data-driven model is integrated within a process simulation model using biased predictions of process variables to capture various benefits of the prediction output of the data-driven model. In some embodiments, the process simulation model is configured to simulate the execution of the at least one process at one or more operating conditions of a plurality of operating conditions. In some embodiments, the process simulation model includes the data-driven model and a first principles model. In some embodiments, the first principles model is configured to generate second model-predicted data (e.g., first principles-driven model-predicted data). In some embodiments, the second model-predicted data includes a predicted value for each of one or more other process variables relative to the target process variables.

At block 606, the apparatus 200 includes first principles-driven prediction circuitry 210, data-driven prediction circuitry 212, optional control circuitry 214, communications circuitry 208, input/output circuitry 206, processor 202, and/or the like, or a combination thereof, that deploys the process simulation model for use. In some embodiments, deploying the process simulation model for use includes receiving input data, generating, using the data-driven model, the first model-predicted data, and applying the model-predicted data in one or more of engineering studies or offline optimization operation. In some embodiments, the input data includes process data associated with the at least one process. In some embodiments, the first model-predicted data is implemented as a constraint in one or more of (i) engineering studies or (ii) optimization operation.

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for data-driven model predictions within a process simulation system, the computer-implemented method comprising:
generating, based on a training dataset, a data-driven model configured to output first model-predicted data associated with at least one process of an industrial plant, wherein the first model-predicted data comprise a predicted value for each of one or more target process variables associated with the at least one process;
integrating the data-driven model within a process simulation model, wherein the process simulation model is configured to simulate the execution of the at least one process at one or more operating conditions of a plurality of operating conditions; and
deploying the process simulation model for use.

2. The computer-implemented method of claim 1, wherein the process simulation model comprise the data-driven model and a first principles model.

3. The computer-implemented method of claim 2, wherein the first principles model is configured to generate second model-predicted data, wherein the second model-predicted data comprise a predicted value for each of one or more other process variables relative to the one or more target process variables.

4. The computer-implemented method of claim 1, wherein deploying the process simulation model for use comprises:
receiving input data, wherein the input data comprise process data associated with the at least one process;
generating, using the data-driven model, the first model-predicted data; and
applying the model-predicted data in one or more of (i) engineering studies or (ii) offline optimization operation.

5. The computer-implemented method of claim 1, wherein the first model-predicted data is implemented as a constraint in one or more of (i) engineering studies or (ii) optimization operation.

6. The computer-implemented method of claim 1, wherein the data-driven model is configured to model the at least one process.

7. The computer-implemented method of claim 1, wherein the data-driven model comprises a neural network model.

8. The computer-implemented method of claim 1, wherein the data-driven model comprises a regression model.

9. The computer-implemented method of claim 1, wherein the data-driven model is previously trained using one or more supervised training techniques.

10. The computer-implemented method of claim 2, wherein the data-driven model is trained using the training dataset, wherein the training dataset comprises a plurality of sets of historical process data and corresponding ground truth data for one or more target process variables.

11. The computer-implemented method of claim 2, wherein the historical process data in each set of historical process data and corresponding ground truth data comprises one or more of (i) historical predicted values for the one or more target process variables or (ii) historical values for a set of measured process variables.

12. An apparatus comprising at least one processor and at least one non-transitory memory comprising program code stored thereon, wherein the at least one non-transitory memory and the program code are configured to, with the at least one processor, cause the apparatus to at least:
generate, based on a training dataset, a data-driven model configured to output first model-predicted data associated with at least one process of an industrial plant, wherein the first model-predicted data comprise a predicted value for each of one or more target process variables associated with the at least one process;
integrate the data-driven model within a process simulation model, wherein the process simulation model is configured to simulate the execution of the at least one process at one or more operating conditions of a plurality of operating conditions; and
deploy the process simulation model for use.

13. The apparatus of claim 12, wherein the process simulation model comprise the data-driven model and a first principles model.

14. The apparatus of claim 13, wherein the first principles model is configured to generate second model-predicted data, wherein the second model-predicted data comprise a predicted value for each of one or more other process variables relative to the one or more target process variables.

15. The apparatus of claim 12, wherein deploying the process simulation model for use comprises:
receiving input data, wherein the input data comprise process data associated with the at least one process;
generating, using the data-driven model, the first model-predicted data; and
applying the model-predicted data in one or more of (i) engineering studies or (ii) offline optimization operation.

16. The apparatus of claim 12, wherein the first model-predicted data is implemented as a constraint in one or more of (i) engineering studies or (ii) optimization operation.

17. The apparatus of claim 12, wherein the data-driven model is configured to model the at least one process.

18. The apparatus of claim 12, wherein the data-driven model comprises a neural network model.

19. The apparatus of claim 12, wherein the data-driven model comprises a regression model.

20. A computer program product comprising at least one non-transitory computer-readable storage medium having computer-readable program code portions stored therein, the computer-readable program code portions comprising an executable portion configured to:
generate, based on a training dataset, a data-driven model configured to output first model-predicted data associated with at least one process of an industrial plant, wherein the first model-predicted data comprise a predicted value for each of one or more target process variables associated with the at least one process;
integrate the data-driven model within a process simulation model, wherein the process simulation model is configured to simulate the execution of the at least one process at one or more operating conditions of a plurality of operating conditions; and
deploy the process simulation model for use.
